(19) United States
(12) Patent Application Publication
(10) Pub. No.: US 2013/0219192 A1
(43) Pub. Date: Aug. 22, 2013

(54) CONTENTS SECURITY APPARATUS AND METHOD THEREOF

(71) Applicant: SAMSUNG ELECTRONICS CO. LTD., (US)

(72) Inventors: Seul-Han PARK, Yongin-si (KR); Yang-Soo LEE, Yongin-si (KR); Moon-Su CHANG, Suwon-si (KR)

(73) Assignee: SAMSUNG ELECTRONICS CO. LTD., Suwon-si (KR)

(21) Appl. No.: 13/770,667

(22) Filed: Feb. 19, 2013

(30) Foreign Application Priority Data
Feb. 16, 2012 (KR) 10-2012-0016090

(51) Int. Cl. G06F 21/60

(52) U.S. Cl. CPC G06F 21/602
USPC 713/190

(57) ABSTRACT

A contents security apparatus for preventing Standard Definition (SD) contents which are protected targets of a level which is relatively lower than that of High Definition (HD) contents from being processed through a trust zone of a processor thereof and a method thereof are provided. The contents security apparatus includes a processor for operating a first Operating System (OS) and for storing authentication information of at least one or more contents and a second OS for limiting access to the first OS, wherein the first OS decrypts and processes contents with a high security level and wherein the second OS decrypts and processes contents with a low security level.

### PRIORITY

This application claims the benefit under 35 U.S.C. §119(a) of a Korean patent application filed on Feb. 16, 2012 in the Korean Intellectual Property Office and assigned Serial No. 10-2012-0016090, the entire disclosure of which is hereby incorporated by reference.

### BACKGROUND OF THE INVENTION

1. Field of the Invention

The present invention relates to a contents security apparatus and a method thereof More particularly, the present invention relates to a contents security apparatus for preventing security authentication of contents with a low security level from being performed through a trusted zone of a processor.

2. Description of the Related Art

Portable electronic devices, such as mobile terminals (cellular phones), electronic schedulers, personal complex terminals, and the like, have become necessities of current society based on advances of electronic communication industries. The portable electronic devices have developed into important means of information transmission, which are quickly changed.

Recently, contents for portable electronic devices have established themselves as targets for creating a high value and contents that can provide an interest to a user are increasing competitively. However, cases of illegally distributing contents have also been increasing and affecting everyone, especially the user.

In order to address this issue, technologies for security extension of contents are applied to each of the portable electronic devices. For example, each of the portable electronic devices includes a trusted zone in hardware on a processor and stores authentication information of contents in the trust zone. When a user of each of the portable electronic devices wants to reproduce contents, each of the portable electronic devices proceeds with a secure process for performing security authentication of the contents, that is, decrypting the contents using the authentication information stored in the trusted zone. Each of the portable electronic devices may further include a secure Operating System (OS) for proceeding with the secure process on the same processor to be independent of an existing open OS. Each of the portable electronic devices protects the secure process of the secure OS from codes of a process with which the open OS proceeds. Therefore, the secure process through the trust zone tightens up security of contents.

In general, image quality of Standard Definition (SD) contents is lower than that of High Definition (HD) contents. The SD contents are protected targets with a level which is lower than that of the HD contents. A portable electronic device of the related art applies the SD contents and the HD contents to the secure process using the trusted zone. As described above, the SD contents are protected targets with the level which is lower than that of the HD contents. Accordingly, there is unnecessary waste of resources (e.g., hardware or software components) by applying the SD contents to the secure process.

Therefore, a need exists for a contents security apparatus for preventing security authentication of contents with a low security level from being performed through a trusted zone of a processor and a method thereof

The above information is presented as background information only to assist with an understanding of the present disclosure. No determination has been made, and no assertion is made, as to whether any of the above might be applicable as prior art with regard to the present invention.

### SUMMARY OF THE INVENTION

Aspects of the present invention are to address at least the above-mentioned problems and/or disadvantages and to provide at least the advantages described below. Accordingly, an aspect of the present invention is to provide a contents security apparatus for preventing security authentication of contents with a low security level from being performed through a trusted zone of a processor and a method thereof.

Another aspect of the present invention is to provide a contents security apparatus for saving resources by preventing a secure process through a trusted zone of a processor from proceeding with Standard Definition (SD) contents which are not protected targets and a method thereof

In accordance with an aspect of the present invention, a contents security apparatus is provided. The apparatus includes a processor for operating a first Operating System (OS) for storing authentication information of at least one or more contents and a second OS for limiting access to the first OS, wherein the first OS decrypts and processes contents with a high security level and wherein the second OS decrypts and processes contents with a low security level.

In accordance with another aspect of the present invention, a contents security method is provided. The method includes decrypting and processing contents with a high security level at the first OS and decrypting and processing contents with a low security level at the second OS.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features, and advantages of certain exemplary embodiments of the present invention will be more apparent from the following description taken in conjunction with the accompanying drawings, in which:

FIG. 1 is a block diagram illustrating a configuration of a portable electronic device according to an exemplary embodiment of the present invention;

FIG. 2 illustrates an architecture of a contents security apparatus according to an exemplary embodiment of the present invention; and

FIG. 3 illustrates a process of processing contents at a processor according to an exemplary embodiment of the present invention.

Throughout the drawings, it should be noted that like reference numbers are used to depict the same or similar elements, features, and structures.

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. In addition, descriptions of well-known functions and constructions may be omitted for clarity and conciseness.

The terms and words used in the following description and claims are not limited to the bibliographical meanings, but, are merely used by the inventor to enable a clear and consistent understanding of the invention. Accordingly, it should be apparent to those skilled in the art that the following description of exemplary embodiments of the present invention is provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

By the term “substantially” it is meant that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

Exemplary embodiments of the present invention relate to a contents security apparatus for preventing Standard Definition (SD) contents.

Hereinafter, a description will be given for a contents security apparatus and a method thereof More particularly, a description will be given for a contents security apparatus for preventing security authentication of SD contents which are protected targets of a level which is relatively lower than that of High Definition (HD) contents from being performed through a trusted zone of a processor and a method thereof A description will be given for a contents security apparatus for saving resources by preventing a secure process through a trusted zone of a processor from proceeding with SD contents which are not protected targets and a method thereof

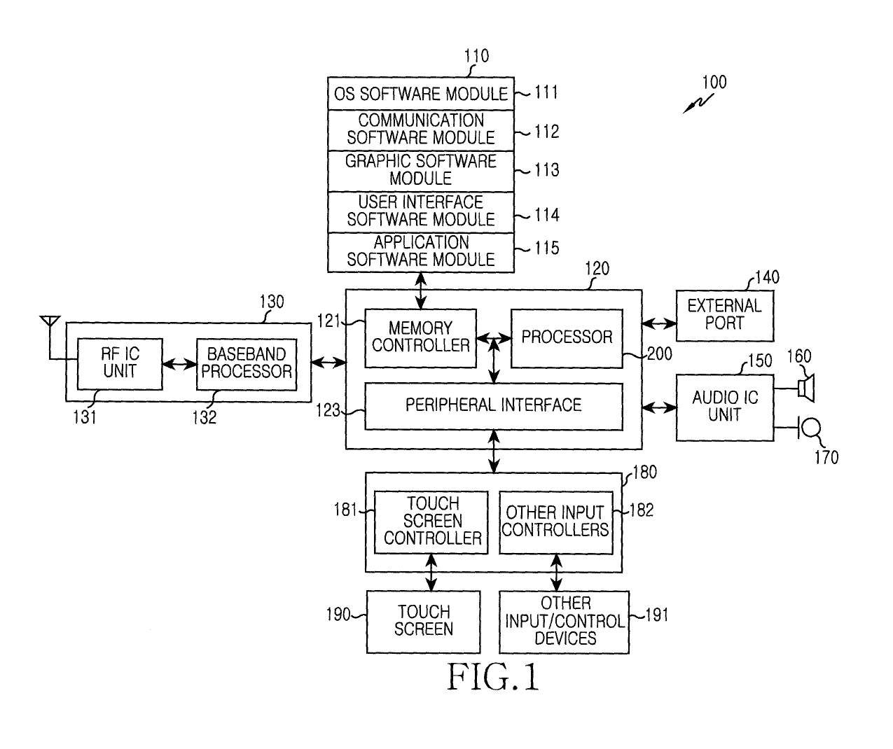

FIG. 1 is a block diagram illustrating a configuration of a portable electronic device according to an exemplary embodiment of the present invention.

Referring to FIG. 1, the portable electronic device 100 may be one of a portable terminal, a mobile phone, a mobile pad, a media player, a tablet computer, a handheld computer, a Personal Digital Assistant (PDA), and the like. In addition, the electronic device 100 may be a device in which two or more functions are combined among these apparatuses.

The portable electronic device 100 includes a memory 110, a processor unit 120, a communication unit 130, an external port 140, an audio Integrated Circuit (IC) unit 150, a speaker 160, a microphone 170, an Input/Output (I/O) system 180, a touch screen 190, and other input/control devices 191. In addition, the memory 110 and the external port 140 may be a plurality of memories and external ports, respectively.

The processor unit 120 may include a memory controller 121, a processor (e.g., a Central Processing Unit (CPU)) 200, and a peripheral interface 123. The processor unit 120 may include a plurality of processors.

The communication unit 130 includes a baseband processor 132 and a Radio Frequency (RF) IC unit 131.

The I/O system 180 includes a touch screen controller 181 and other input controllers 182.

The components of the portable electronic device 100 communicate with each other through one or more communication buses or signal lines (not written in reference numbers).

Each of these components may implement its function in hardware, such as one or more ICs, or in software. In addition, each of the components may implement its function by combination of hardware and software.

The portable electronic device 100 may include more components than those shown in FIG. 1. Alternatively, the portable electronic device 100 may include fewer components than those shown in FIG. 1. The portable electronic device 100 may be configured by a type which is different from a type shown in FIG. 1. A description will be given with respect to the various components.

The memory 110 may include a Random Access memory (RAM), a non-volatile memory including a flash memory, a Read Only Memory (ROM), an Electrically Erasable Programmable ROM (EEPROM) or a magnetic disc storage device, a Compact Disc-ROM (CD-ROM), a Digital Versatile Disc (DVD) or another optical storage device, and a magnetic cassette. Alternatively, the memory 110 may be configured by combination of some or all of them.

In addition, the memory 110 may further include an attachable storage device capable of accessing the portable electronic device 100 through each of communication networks, such as the Internet, an intranet, a Local Area Network (LAN), a Wide LAN (WLAN), and a Storage Area Network (SAN) or a communication network configured by combination of them. This storage device may access the portable electronic device 100 through the external port 140. A separate storage device on a communication network may access the portable electronic device 100 through the RF IC unit 131.

The memory 110 stores software components that include an Operating System (OS) software module 111, a communication software module 112, a graphic software module 113, a user interface software module 114, and one or more application software modules 115. The software modules are expressed in an instruction set.

The OS software module 111, for example, at least one of Windows, Linux, Darwin, RTXC, UNIX, OS X, VxWorks, and the like, includes several software components for controlling a general system operation. For example, control of this general system operation means memory management and control, storage hardware (device) control and management, power control and management, and the like. The OS software module 111 also performs a function for smoothly communicating between several hardware components (devices) and several software components.

The communication software module 112 includes several software components for processing data transmitted and received through the RF IC unit 131 or the external port 140.

The graphic software module 113 includes several software components for providing and displaying graphics, for example, texts, web pages, icons, digital images, videos, animations, and the like, on the touch screen 190.

The user interface software module 114 includes several software components related to a user interface. The user interface software module 114 includes contents about whether a state of a user interface is changed to any state, whether a state of a user interface is changed in any condition, and the like.

The application software module 115 includes a browser function, an email function, an instant message function, a word processing function, a keyboard emulation function, an address book function, a touch list function, a widget function, a Java enable application function, a coding function, a Digital Right Management (DRM) function, a voice recognition function, a voice copy function, a position determining function, a location based service function, a music player function, and the like.

The memory controller 121 controls that the processor 200 or the peripheral interface 123 of the processor unit 120 accesses the memory 110.

The external port 140, for example, one of a Universal Serial Bus (USB) port, a firewire port, and the like, connects the portable electronic device 100 to another electronic device directly or connects it to another electronic device indirectly through a network (e.g., the Internet, an intranet, a wireless Local Area Network (LAN), and the like).

The peripheral interface 123 connects I/O peripherals of the portable electronic device 100 to the processor 200 and the memory 110 (under control of the memory controller 121).

The processor 200 processes and controls voice communication, video communication, data communication, and various functions of the portable electronic device 100 using several software programs. In addition, the processor 200 plays a role in executing a corresponding software module (instruction set) stored in the memory 110 and performing a function corresponding to the software module. The processor 200, the peripheral interface 123, and the memory controller 121 may be implemented in a single chip, in this case, the processor unit 120. The processor 200, the peripheral interface 123, and the memory controller 121 may be implemented in, but are limited to, separate chips, respectively.

The communication unit 130 includes the RF IC unit 131 and the baseband processor 132. The RF IC unit 131 transmits and receives electromagnetic waves. The RF IC unit 131 converts a baseband signal received from the baseband processor 132 into an electromagnetic wave and transmits the converted electromagnetic wave through an antenna (not written in reference numbers). In addition, the RF IC unit 131 converts an electromagnetic wave received from the antenna into a baseband signal and provides the converted baseband signal to the baseband processor 132. The RF IC unit 131 includes an RF transceiver, an amplifier, a tuner, an oscillator, a digital signal processor, a COding DECoding (CODEC) chip set, a Subscriber Identity Module (SIM) card, and the like.

The RF IC unit 131 communicates with a communication network and another communication device through electromagnetic waves. For example, the RF IC unit 131 may communicate with a wireless network, such as the Internet, an intranet, a cellular phone network, a wireless LAN, or a wireless Metropolitan Area Network (MAN). The RF IC unit 131 may communicate with another electronic device by wireless communication. The wireless communication may be performed by a Time Division Multiple Access (TDMA) communication scheme, a Global System for Mobile communication (GSM) communication scheme, an Enhanced Data GSM Environment (EDGE) communication scheme, a Code Division Multiple Access (CDMA) communication scheme, a W-CDMA (Wideband CDMA) communication scheme, a Bluetooth communication scheme, a Voice over Internet Protocol (VoIP) communication scheme, a Wireless Fidelity (Wi-Fi) communication scheme, a WiMax communication scheme, an e-mail communication scheme, an instant messaging communication scheme, a protocol communication scheme for Short Message Service (SMS), or a random combination of these several communication schemes.

For example, the RF IC unit 131 converts an RF signal received through the antenna into a baseband signal and provides the converted baseband signal to the baseband processor 132. The RF IC unit 131 converts a baseband signal received from the baseband processor 132 into an RF signal and transmits the converted RF signal through the antenna. The baseband processor 132 processes the baseband signal. When transmitting data in the CDMA communication scheme, the baseband processor 132 performs a function for performing channel decoding and spreading of the data to be transmitted. When receiving data, the baseband processor 132 performs a function for performing dispreading and channel decoding of the received data.

The audio IC unit 150 communicates with a user through the speaker 160 and the microphone 170. For example, the audio IC unit 150 is related to the speaker 160 and the microphone 170, and provides an audio interface between the user and the portable electronic device 100. The audio IC unit 150 receives a data signal from the peripheral interface 123 of the processor unit 120 and converts the received data signal into an electric signal. The converted electric signal is transmitted to the speaker 160. The speaker 160 converts the electric signal into a sound wave to which the user may listen and outputs the converted sound wave. The microphone 170 converts a sound wave transmitted from the user or other sound sources into an electric signal. The audio IC unit 150 receives the converted electric signal from the microphone 170. The audio IC unit 150 converts the received electric signal into an audio data signal and transmits the converted audio data signal to the peripheral interface 123. The audio data signal is transmitted to the memory 110 or the communication unit 130 through the peripheral interface 123. The audio IC unit 150 may include a jack (not shown) for providing an interface with an attachable and detachable earphone, headphone, or headset. The headset may perform all of output (headphone for one or two ears) and input (microphone). The jack may include either or both of an earphone jack or a headset jack.

The I/O system 180 provides an interface between I/O devices, such as the touch screen 190 and the other input/control devices 191, and the peripheral interface 123. The I/O system 180 includes a touch screen controller 181 and the other input controllers 182 for the other input/control devices 191. The other input controllers 182 may be a plurality of other input controllers. The other input controllers 182 transmit and receive an electric signal with the other input/control devices 191. The other input/control devices 191 may include buttons, dials, sticks, switches, and the like. The buttons may include a push button, a rocker button, and the like.

The touch screen 190 provides an input/output interface between the portable electronic device 100 and the user. For example, the touch screen 190 transmits touch input of the user to the portable electronic device 100. The touch screen 190 displays visual output from the portable electronic device 100 to the user. The visual output through the touch screen 190 has a text type, a graphic type, a video type, and a combined type of them.

The user inputs a touch input through a touch event on the touch screen 190 according to a haptic touch type, a tactile touch type, or a combined type of them. The touch screen 190 has a touch detecting surface for receiving a user input. For example, a touch point between the touch screen 190 and the user corresponds to a width of a finger used by a user touch. In addition, the user may touch the touch screen 190 using a suitable object, such as a stylus pen. If the user inputs a touch input through the touch screen 190, the touch screen 190 interworks with the touch screen controller 181 and a software module (instruction set) related to the touch screen controller 181, and detects the touch input on the touch screen 190. The detected touch input is converted into interaction corresponding to a user interface object (e.g., a soft key) displayed on the touch screen 190.

The touch screen 190 may be implemented by any of several display technologies, for example, a Liquid Crystal Display (LCD) technology, a Light Emitting Diode (LED) technology, and a Light emitting Polymer Display (LPD) or an Organic Light Emitting Diode (OLED) technology. The touch screen 190 and the touch screen controller 181 may detect the start of a touch, movement of a touch, or a pause or stop of a touch using several touch detecting technologies, such as a capacitive detection technology, a resistive detection technology, an infrared detection technology, a surface acoustic wave detection technology, and the like. In addition, the touch screen 190 may also use a proximity sensor array technology or other technologies capable of determining a touch point on the touch screen 190. In addition, the portable electronic device 100 may also use a touch detecting tablet for not displaying visual output and for detecting only a touch input.

The portable electronic device 100 may include a touch pad (not shown) for activating or inactivating a specific function in addition to the touch screen 190. The touch pad detects only a touch input without displaying visual output to be different from the touch screen 190. The touch pad may have a separate touch detecting surface which is separated from the touch screen 190, or may be configured in an enlargement portion of a touch detecting surface where the touch screen 190 is configured.

A touch through the touch screen 190 is detected by an operation of the touch screen controller 181 and a touch detecting software. The touch screen controller 181 transmits and receives an electric signal with the touch screen 190. The touch detecting software is stored as a touch detecting software module (not shown) in the memory 110. The touch detecting software module includes several software components for determining several operations related to a touch of the touch screen 190. These software components perform determination for whether the touch screen 190 is touched, determination for movement of a touch, determination for movement direction and time of a touch, determination for whether a touch is stopped, and the like. The determination for the movement of the touch may include determination for determining a movement speed (including magnitude or/and direction) of the touch or/and acceleration (including magnitude or/and direction) of the touch.

The portable electronic device 100 may receive an input according to motion of the user. The input may be detected by an operation of the touch screen controller 181 and a motion detecting software. The touch screen controller 181 transmits and receives an electric signal with the touch screen 190. The motion detecting software is stored as a motion detecting software module (not shown) in the memory 110. The motion detecting software module includes several software components for detecting motion on the touch screen 190 and for determining related motion. These software components perform determination for motion start on the touch screen 190, determination for movement of motion, determination for movement direction and time of motion, determination for whether motion is stopped and the like. The determination for the movement of the motion may include determination for determining a movement speed (including magnitude or/and speed) of the motion or/and acceleration (including magnitude or/and direction) of the motion.

In addition, the portable electronic device 100 includes a power system (not shown) for supplying power to the above-described components. The power system may include a power source (i.e., an Alternating Current (AC) power source or a battery), a power error detection circuit, a power converter, a power inverter, a charging device, or/and a power state display device (an LED). In addition, the power system may include a power management and control device for performing generation, management, and distribution functions of power.

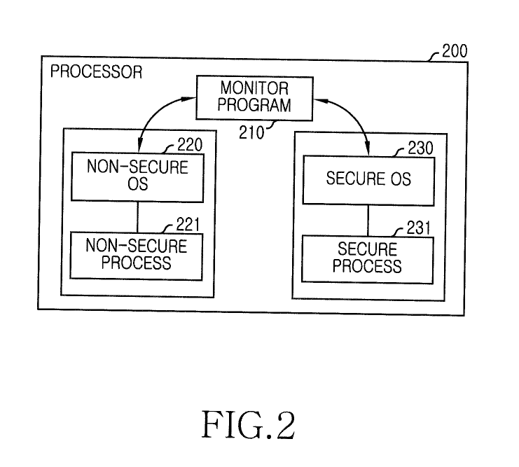

FIG. 2 illustrates an architecture of a contents security apparatus according to an exemplary embodiment of the present invention.

Referring to FIG. 2, a processor 200 proceeds with a non-secure process 221 or a secure process 231 which is as a processing means for several programs. The processor 200 provides a monitor program 210 which is at least partially processed in a monitor mode. The monitor program 210 manages conversion between a non-secure area and a secure area. In the processor 200, the monitor mode is always stable and there is the monitor program 210 in a secure memory. The non-secure area provides a non-secure OS 220 and the non-secure process 221 proceeds through the non-secure OS 220. The secure area provides a secure OS 230 and the secure process 231 proceeds through the secure OS 230. In implementing the secure OS 230, it provides only functions needed for processing information in the secure area.

The non-secure OS 220 may not access the secure OS 230. For example, the secure OS 230 is perfectly protected from codes of the non-secure process 221 with which the non-secure OS 220 proceeds.

The secure OS 230 stores authentication information about contents with a high security level. In general, the processor 200 has an area, called a trusted zone, which has improved security and stability. The processor 200 stores authentication information of contents processed by the secure OS 230. The trusted zone protects contents downloaded to a device or executed contents and enhances reliability for contents.

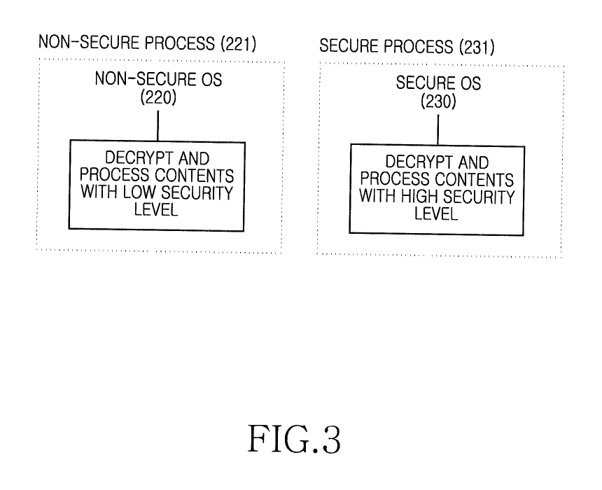

FIG. 3 illustrates a process of processing contents at a processor according to an exemplary embodiment of the present invention.

Referring to FIG. 3, a secure OS 230 performs a secure process 231 for decrypting and processing contents with a high security level using authentication information which is stored and managed in a trusted zone.

On the other hand, a non-secure OS 220 does not use the trusted zone and performs a non-secure process 221 for decrypting and processing contents with a security level which is relative lower than that of the secure OS 230.

In accordance with an exemplary embodiment of the present invention, HD contents have a high security level and SD contents have a low security level. The secure OS 230 decrypts and processes the HD contents using the trusted zone and the non-secure OS 220 decrypts and processes the SD contents without using the trusted zone.

The secure OS 230 may save resources by not processing all of contents with a high security level and contents with a low security level and performing the secure process 231 using the trusted zone with respect to only the contents with the high security level.

A contents security apparatus and a method thereof according to exemplary embodiments of the present invention save resources by preventing a secure process through a trusted zone of a processor from proceeding with processing SD contents which are not protected targets.

While the present invention has been particularly shown and described with reference to exemplary embodiments thereof, it will be understood by those skilled in the art that various changes in form and details may be made therein without departing from the spirit and scope of the present invention as defined by the appended claims.

In addition, exemplary methods according to claims of the present invention and/or exemplary embodiments described in the specification of the present invention may be implemented as hardware, software, or combinational type of the hardware and the software.

When the method is implemented by the software, a computer-readable storage medium for storing one or more programs (software modules) may be provided. The one or more programs stored in the computer-readable storage medium are configured for being executed by one or more processors in the portable electronic device 100. The one or more programs include instructions for allowing the portable electronic device 100 to execute the exemplary methods according to the claims of the present invention and/or the exemplary embodiments described in the specification of the present invention.

These programs may be stored in a RAM, a non-volatile memory including a flash memory, a ROM, an EEPROM, a magnetic disc storage device, a CD-ROM, a DVD or an optical storage device of a different type, and a magnetic cassette. Alternatively, the programs may be stored in a memory configured by combination of some or all of them. In addition, the configured memory may include a plurality of memories.

While the invention has been shown and described with reference to certain exemplary embodiments thereof, it will be understood by those skilled in the art that various changes in form and details may be made therein without departing from the spirit and scope of the invention as defined by the appended claims and their equivalents.

What is claimed is:

1. A contents security apparatus comprising a processor for operating a first Operating System (OS) and for storing authentication information of at least one or more contents and a second OS for limiting access to the first OS,
wherein the first OS decrypts and processes contents with a high security level and wherein the second OS decrypts and processes contents with a low security level.

2. The apparatus of claim 1, wherein the contents with the high security level are High Definition (HD) contents.

3. The apparatus of claim 1, wherein the contents with the low security level are Standard Definition (SD) contents.

4. The apparatus of claim 1, wherein the processor includes a secure area for operating the first OS and a non-secure area for operating the second OS.

5. The apparatus of claim 4, wherein the processor executes a monitor program for managing conversion between the secure area and the non-secure area.

6. A contents security method of a processor for operating a first Operating System (OS) and for storing authentication information of at least one or more contents and a second OS for limiting access to the first OS, the method comprising:
decrypting and processing contents with a high security level at the first OS; and
decrypting and processing contents with a low security level at the second OS.

7. The method of claim 6, wherein the contents with the high security level are High Definition (HD) contents.

8. The method of claim 6, wherein the contents with the low security level are Standard Definition (SD) contents.

9. The method of claim 6, wherein the processor includes a secure area for operating the first OS and a non-secure area for operating the second OS.

10. The method of claim 9, further comprising converting between the secure area and the non-secure area.
